(19) United States
(12) Patent Application Publication
(10) Pub. No.: US 2005/0091218 A1
(43) Pub. Date: Apr. 28, 2005

(54) System and process providing remote data capture with later upload to a real estate multiple listing service

(75) Inventors: David Michael Janes, Roswell, GA (US); Rodney Warren Oberg, Marietta, GA (US); Michael A. Ferguson, Acworth, GA (US)

Correspondence Address: OFFICE at Hand, Inc., Suite 253, 3232 Cobb Parkway, Atlanta, GA, 30339-3896, US

(73) Assignee: OFFICE at Hand, Inc, Atlanta, GA (US)

(21) Appl. No.: 10/709,486

(22) Filed: May 9, 2004

Related U.S. Application Data
(60) Provisional application No. 60/469,133, filed on May 12, 2003.

(51) Int. Cl. G06F 7/00

(52) U.S. Cl. 707/10

(57) ABSTRACT

A system and process for capturing all regionally supported data regarding a real estate property for sale, and a system and process for loading that captured data to a regional multiple listing database system, using a portable computing device is detailed. A general purpose portable computing device (such as the Palm OS personal data assistant PCD, or the handheld Microsoft Pocket PC, HPC) is capable of running custom software applications for the collection and display of information and can be configured to store collected information in persistent storage, for later retrieval and manipulation, on the portable computing device. A regional multiple listing service maintains a database and search engine of all properties listed for sale in a specific geographic region, and which are listed for sale with a licensed real estate agent. This system provides a software application on the portable computing device which allows the real estate agent to collect all the necessary data, while in the field, to create a listing entry in the multiple listing database. The system is configured such that the field collected data can be automatically published to the multiple listing database at the next opportunity the real estate agent has to synchronize the portable computing device with an Internet connected computer. The system is also configured to correct common data collection mistakes made by a plurality of real estate agents, and also correct common mistakes made while transcribing the data into the multiple listing database.

### CROSS REFERENCE TO RELATED APPLICATIONS

This application is a non-provisional patent application for the provisional patent: U.S. provisional patent application No. 60/469,133, filed May 12, 2003, the disclosures of which are incorporated herein by reference.

### BACKGROUND OF INVENTION

As a general rule, all real estate sold in the United States through a licensed real estate agent will be listed on at least one real estate database called a Multiple Listing Service (MLS). Individual real estate agents subscribe to the services of an MLS, and use the multiple listing service in an attempt to match buyers and sellers based on a standard and detailed list of property attributes. MLS attributes usually include all aspects of a home s construction, style, neighborhood, area, school districts, lot dimensions, exterior features, agent's comments, property directions, showing instructions, selling price, property taxes, closing and possession instructions, etc. MLS databases collect on the order of 500 to 700 pieces of discrete data about each property listed in the system. MLS system attempt to match buyer profiles requesting specific attributes about a property with “for sale” inventory in the MLS database. Real estate agents use these systems extensively when selecting potential properties to show a qualified buyer.

Today, all data about a property which enters the MLS system, starts off as the collection of said data on paper based forms while at the property with the seller. These forms are typically two or three legal sized sheets of paper with “check box” and “fill in the blank” attributes describing the real estate property. Once this data is collected by the agent, while at the seller's property, the agent must then return to the office and enter the data into an MLS system. Sometimes, the agent gives the completed paper forms to a secretary who enters the data on the agent's behalf.

This transcription of data from paper based forms to electronic forms often introduces errors during the transcription process. Sometimes, because the transcription effort is laborious, agents enter the majority of information from memory, only capturing the minimal amount of paper information necessary to complete a listing entry in the MLS system. This effort saving step also causes the introduction of many errors in the MLS data regarding a property. To complicate matters further, some real estate markets, like Atlanta, Ga., have two or more competing MLS systems, thereby doubling the effort, and likelihood of error, necessary to get the listing data to both MLS systems.

In addition to the data errors entered through the transcription from paper or memory, many errors are introduced from the lack of standard definition in real estate data, and the lack of definition enforcement. For example, asking any five agents for the definition of a “den” will likely yield three different answers ranging from the true definition of “den” to the definition of a “living room” or “family room”.

As a result of this high error rate, users of the MLS system must often compensate for common mistakes made by listing agents by varying their query parameters and buyer profiles in an attempt to locate appropriate properties for their buyers.

Therefore, there is a need for a portable system which can collect all the discrete data elements of a multiple listing system in the filed at the “for sale” property, apply rules to the collected data for accuracy, provide consistent industry definitions for data elements, and publish the collected data directly to the multiple listing service(s).

### SUMMARY OF INVENTION

The present invention describes a data collection and publication software system and process to electronically capture the repetitive, standardized, real estate MLS data, remotely in the field. While this system captures the data, it also checks the data for accuracy, and later uploads and publishes this data to a centralized real estate MLS database.

The preferred embodiment of this invention uses a general purpose portable computing device (PCD), such as those built around the Palm OS termed a Personal Data Assistant (PDA), or the Microsoft handheld Pocket PC operating system termed a Handheld PC (HPC). The PCD running specific application software, which enables the real estate agent to capture all the data elements present on the standardized paper-based real estate MLS form used in their geographic region. This captured data can be stored, recalled, and edited on the PCD in battery backed semi-volatile memory until such time that it is uploaded into a regional MLS system. While the listing data for a property is resident on the PCD, the software application continually checks the data for accuracy and common mistakes. One accuracy check would be to ensure that any property listed as 1½ stories has a master bedroom on main level and at least one or more bedrooms on the upper level. Agents often mistakenly call a 1½ story house a 2 story house.

When a real estate agent is ready to upload the captured listing data into an MLS system, the PCD is then synchronized with a personal computer (PC) which is already running a special synchronization agent software program for the temporary local management of listing data. From the PC, running the special synchronization agent software application for the management of MLS data captured from the PCD, these real estate listings can be uploaded into one or more regional MLS systems.

The preferred embodiment of this invention uploads the managed MLS data from the PC over the Internet through another web application or web service designed to route all uploads through one governing body. This governing body will be responsible to ensure the MLS data is properly entered into the destination MLS system. Likewise, this governing body distributes the electronic MLS forms for use on the agent's PCD, and enforces Agent/Broker/Regional MLS business rules.

### BRIEF DESCRIPTION OF DRAWINGS

FIG. 1A Is Page 1 of 3, Single Family FMLS and GAMLS Dual-Entry Data Entry Form

FIG. 1B Is Page 2 of 3, Single Family FMLS and GAMLS Dual-Entry Data Entry Form

FIG. 1C Is Page 3 of 3, Single Family FMLS and GAMLS Dual-Entry Data Entry Form

FIG. 2 Is a functional system showing all components for the collection, synchronization, and publication of MLS data to regional MLS database systems.

FIG. 3 Are screen shots showing, by way of example, the management of multiple listing entries, the input of multiple listing data, and the selection of data from exclusive lists.

FIG. 4 Are screen shots showing, by way of example, the input of free entry, handwritten data, and the selection of specific data from large managed lists.

FIG. 5 Are screen shots showing, by way of example, the selection of “check box” true or false attributes, and the enforcement of business rules regarding the selection of such data.

FIG. 6 Are screen shots showing, by way of example, the association of industry terms linked to the specific screen in question, and the capture of electronic signatures.

FIG. 7 Is a sample database tables used in one embodiment of the present application.

FIG. 8 Is a flow diagram showing application logic of the data collection application on the PCD.

FIG. 9 Is a flow diagram showing data synchronization logic of the transfer of data from the PCD to an external web service

FIG. 10 Is a flow diagram showing data correction and publication logic used in publishing the collected MLS data to the MLS systems of FIGS. 2 27, 28, 29.

### DETAILED DESCRIPTION

This application is a non-provisional patent application for the U.S. provisional patent application No. 60/469,133, filed May 12, 2003, the disclosures of which are incorporated herein by reference.

The detailed description of the present invention will utilize examples from the Atlanta, Ga. MLS marketplace. Atlanta, Ga. is one of the more complicated geographic areas because real estate agents in Atlanta, Ga. typically list their properties “for sale” with two competing MLS systems. These systems are FMLS (First MLS) and GAMLS (Georgia MLS).

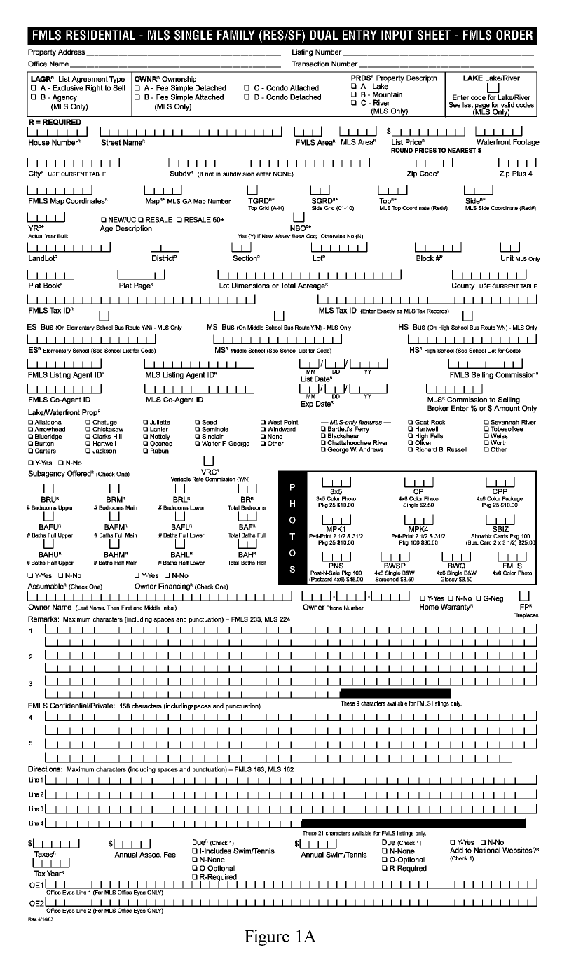

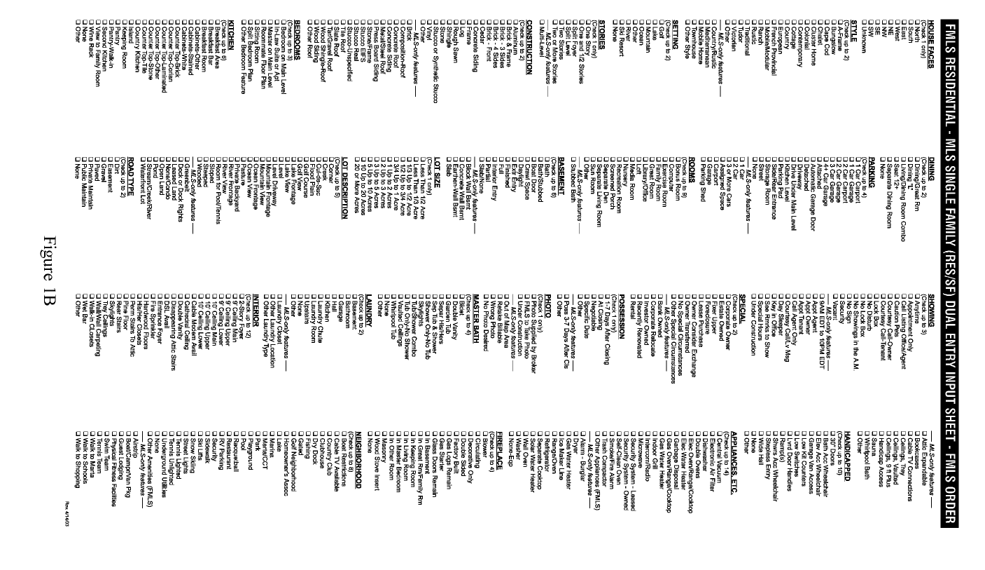

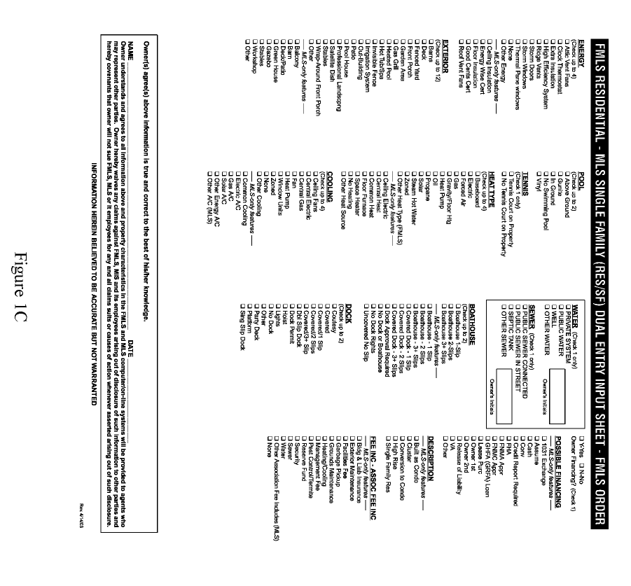

FIGS. 1A, 1B and 1C show the entirety of data collected by both FMLS and GAMLS on a standard “Dual Entry” data sheet. For this invention, these paper based data sheets are encoded into a specific data collection application on the PCD (Palm OS, PDA or Pocket PC, HPC) using a programming language of choice. The present invention utilizes Satellite Forms 5.2a for rapid program generation of data collection applications, but the inventors recognize applications performing the same function written using other programming tools and languages, such as C++ or Java. Each real estate market served by a regional MLS system will start with data collection on forms similar to FIGS. 1A, 1B, and 1C which are tailored to the specific attributes of the regional MLS system.

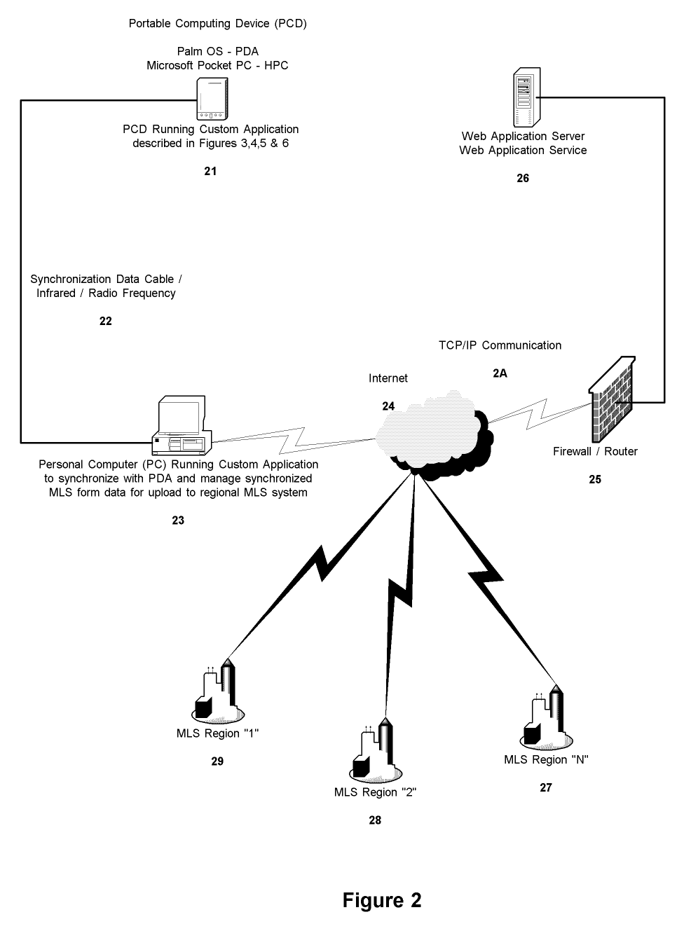

FIG. 2 describes a system with the capability to capture all the MLS data present in FIG. 1A, 1B, and 1C on the PCD 21. The PCD 21 is configured with a custom software application to capture all the data present on the MLS data forms. The PCD 21 holds this MLS data in persistent storage and allows the real estate agent to edit the data for completeness and correctness until all data about a listing is collected.

In the described embodiment of this invention, the PCD 21 of FIG. 2 is a personal data assistant (PDA), such as the Palm m515 or similar member of the Palm family. The PCD could also be a handheld personal computer (HPC) running the Microsoft Pocket PC operating system such as the Dell Axiom. The PCD could also be integrated into Palm and Pocket PC cellular phones, or could be an emerging Tablet PC running the Windows XP operating system such as the Protégé from Toshiba. The PCD could also be a next generation Linux PDA such as the Zarus from Sharp.

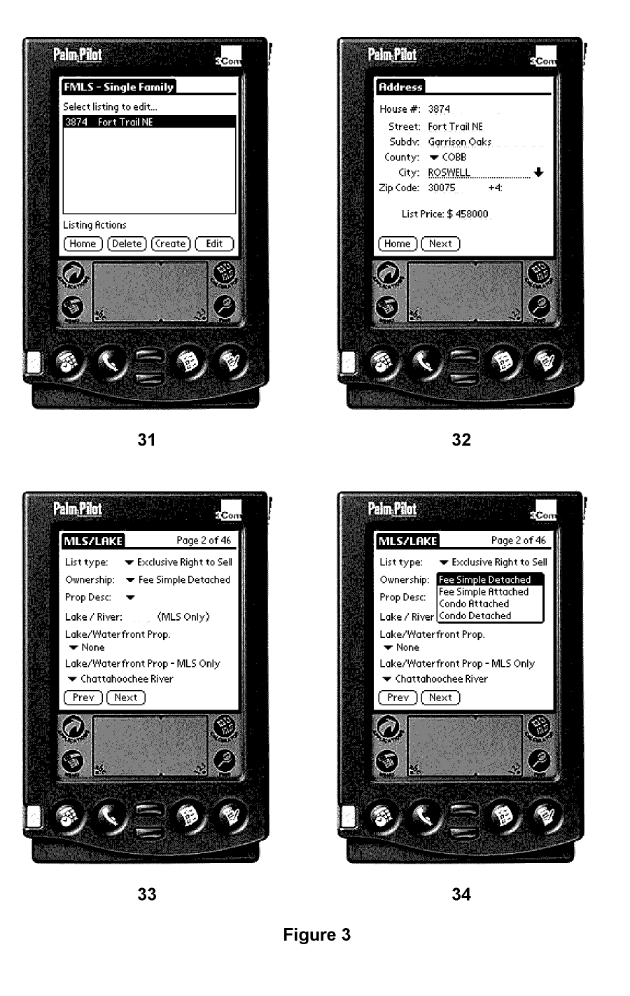

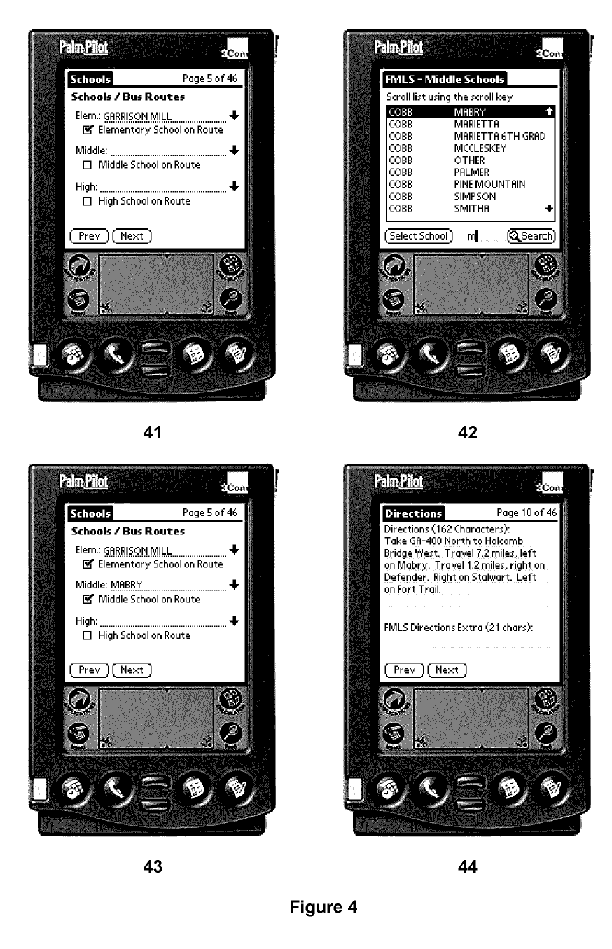

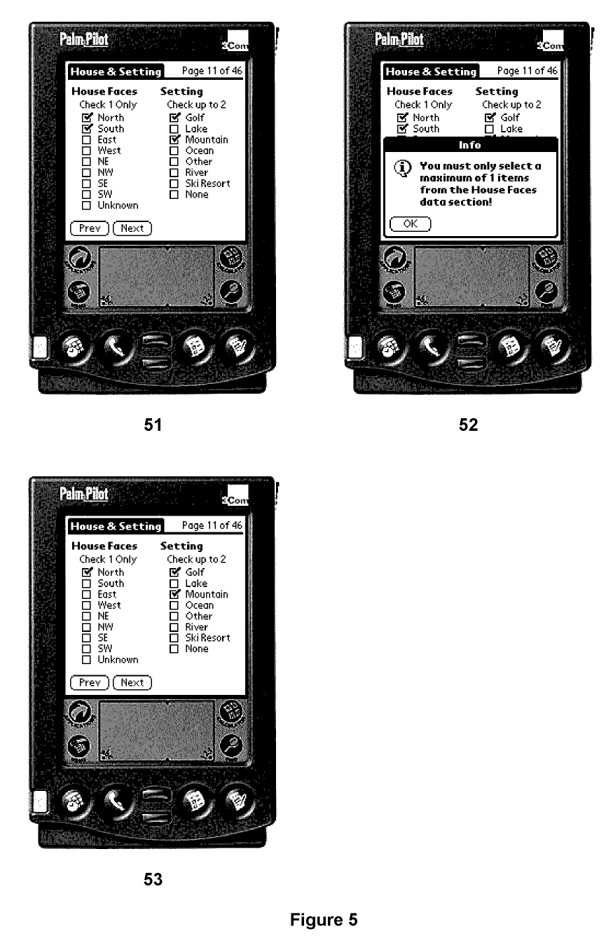

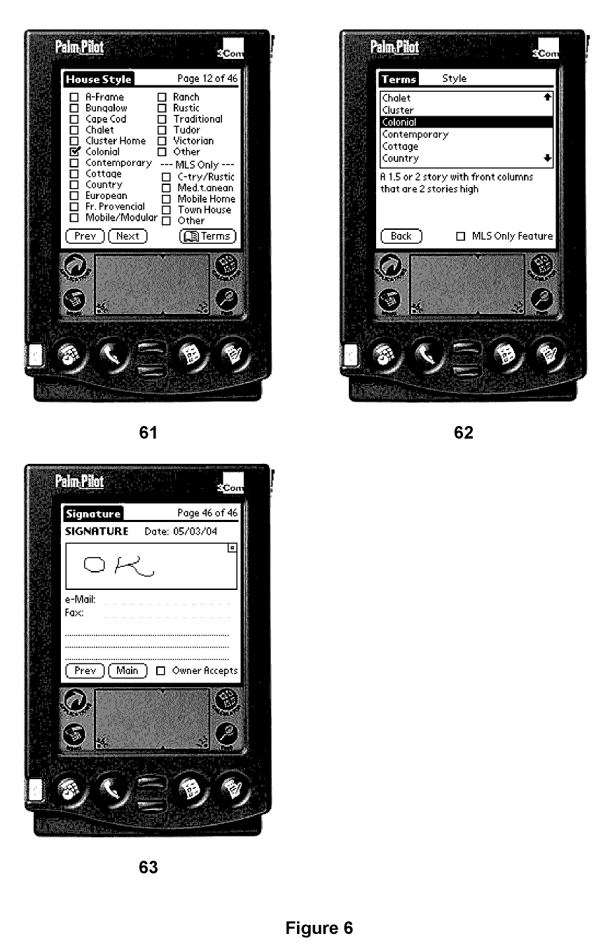

FIG. 3, FIG. 4, FIG. 5, and FIG. 6 show the PCD application responsible for collecting and managing the MLS data. In FIG. 3, the custom PCD application manages a list of MLS properties 31 the real estate agent would like to publish to the MLS system(s). 31 allows the agent to create, edit, and delete property listings before uploading the listings to the MLS system. MLS data entries which are single selections from a finite exclusive list of choices, are represented as drop down selection lists in the PCD application 33 and 34. Attributes such as public schools are typically large lists containing all the public schools in an MLS region. Once the county for the property has been selected 32, the county is used to narrow large lists, such as “Middle School” down to a manageable list filtered by county. The selection mechanism of 41, 42, and 43 key on the county of the property and eliminate the need for the real estate agent to carry listings of schools, cities, MLS areas, and the like. To activate the large list mechanism, the agent simply taps or clicks the down arrow on the right side of the screen on the same line as the data entry blank. The large list selection screen 42 has a quick search feature which allows the agent to enter the first few letters of the desired entry and tap or click the Search button. Screen 42 shows the user has entered “m” and searched instantly to all schools beginning with “m”. The list of available choices has previously been filtered down to only those entries applicable to the county of the property. 44 shows the sections of MLS data where the user is allowed to enter free form text. The user is automatically constrained, as in 44, to the number of supported characters in the MLS system. Data entry sections which allow the agent to pick from a list of attributes are show in 51, 52, and 53. These data entry screens perform rule checking to ensure the agent has not selected more components than are allowed by the regional MLS system. 52 shows the warning message that the agent must select a maximum of N items from the list.

One common problem in the real estate industry is the lack of a consistent set of terms and definitions. The present invention addresses this industry need by bringing terms and definitions to the data input screens on the PCD. 61 of FIG. 6 shows the screen for “House Style” in which the real estate agent is expected to know the difference between many house styles from the exterior appearance. Data entry screens where the data choices are not obvious 61 employ a context sensitive link “Terms” the agent can tap or click to pull a list of industry definitions. The user can scroll the list of definitions using the stylus or PCD scroll buttons to move the current selection 62 up and down the list looking at all the context sensitive definitions for the data input screen 61.

It is a goal of the present invention to completely eliminate the need for paper based MLS data input sheets. To facilitate this goal, the present invention employs electronic signature capture 63 of FIG. 6 within the data capture application. Property sellers must sign the MLS data for accuracy in multiple places. The current invention captures electronic signatures or initials in all places where the seller would have signed the paper based form.

The PCD, 21 of FIG. 2, collects all field data from the real estate agent in a local database system. Tables with layouts similar in structure to the MLS data sheets are employed to hold and edit the MLS data while the real estate agent is using the application. The database system and software allows the agent to collect and manage multiple properties 31 while in the field.

As new property listings are created, 31 of FIG. 3, a database primary key is generated pseudo-randomly for the new property. As would be standard in the art of database design, all data related to the current property, collected in a plurality of individual database tables is linked back to the property through this primary key.

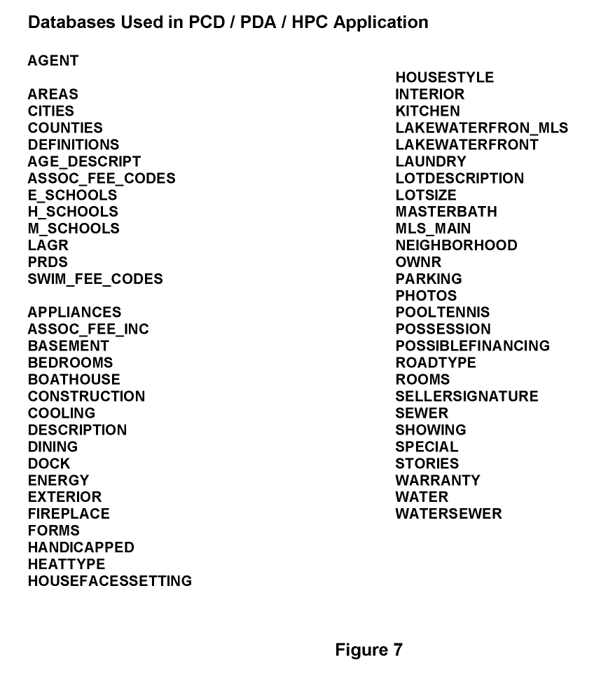

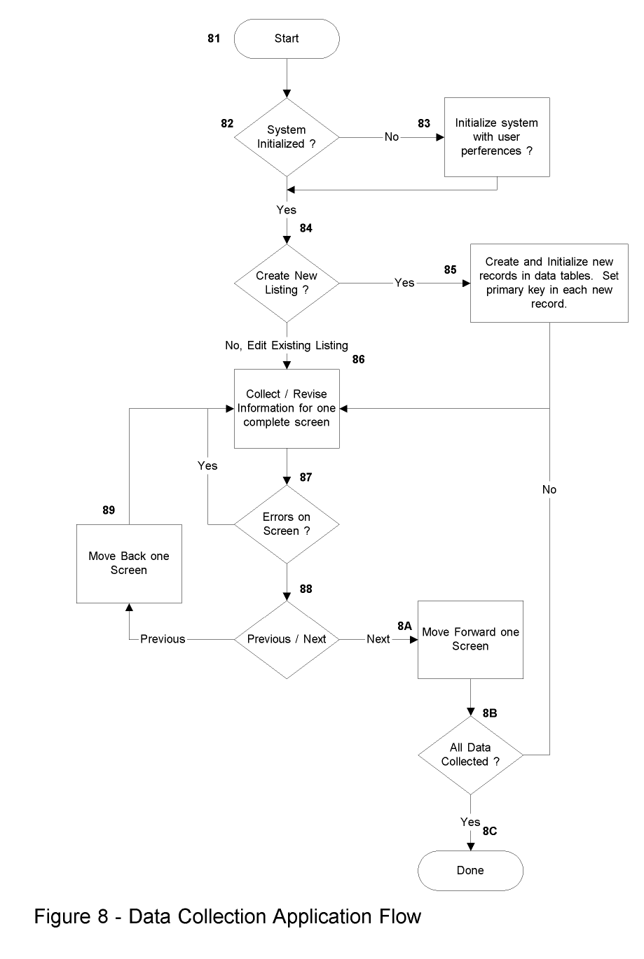

All the MLS data fields required for a complete listing are stored in the database tables of FIG. 7 according to the program flow of FIG. 8. As designed, there is approximately one database table defined for each screen of the PCD application. From FIG. 8, once the user has created a new property listing 85, or selected an existing property to edit 86, the user navigates through all screens using a Next / Previous button model viewed in 41 of FIG. 4. Again from FIG. 8, as the user completes a screen, the data entry application checks the contents of the screen for accuracy 87. If the user is allowed to continue, the navigation is completed, until the user has entered all the data regarding the real estate property.

FIG. 2 also describes a system for publishing and migrating the collected data from the PCD 21 to the destination MLS database systems 27, 28, and 29. The system of FIG. 2 utilizes synchronization software to synchronize the collected data from the PCD 21 to a personal computer, PC, 23. Synchronization takes place between the PCD 21 and PC 23 over a standard synchronization data cable 22, or via Infrared or Wireless radio frequency. Specific software on the PC 23 is employed to synchronize the data collected from the PCD 21 through the Internet 24 to a specific web application designed to hold the collected MLS data. Data is exchanged between the PC 23 and the web application 26 as XML documents. Synchronization from the PC 23 through the Internet 24 takes place over well defined TCP/IP communication channels 2A. During synchronization, the PC 23 sends all collected data to the web application server 26.

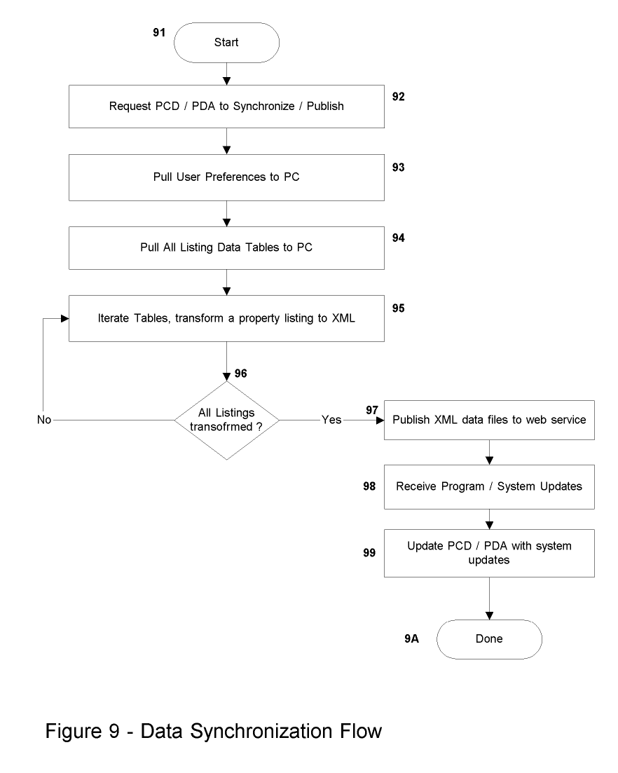

Synchronization, according to FIG. 9, starts when the user requests PCD synchronization with an Internet connected personal computer PC. The user initiates a synchronization session in the normal fashion supported by the PCD, and specific application software installed on the PC first pulls all user preferences 93 from the PCD and then pulls all application defined data tables 94 from the PCD. The specific application software for data synchronization on the PC iterates all the data in the collected tables 95, 96 and composes an XML file describing the collected data. The specific application software on the PC for data synchronization then transmits the collected XML file 97 to the web application server 26 of FIG. 2. The web application server receives the data, determines the correct responses, and delivers any program and data updates back to the synchronization software on the PC. The synchronization software on the PC receives any software and data updates 98 for the PCD and delivers the updates down to the PCD.

The web application server 26 of FIG. 2 is a custom web application which aggregates the collected MLS data from a plurality of real estate agents and publishes the collected data about each property to the regional MLS system configured for each real estate agent. The web application server 26 is capable of authenticating collected data and publishing the collected data to regional MLS systems. Publication of MLS from the web application server 26 again takes place over the Internet 24 through well defined TCP/IP communication channels 2A. The web application is additionally configured to allow the real estate agent to edit the final data set before submitting to the regional MLS system. Once synchronization between the PC 23 and the web application server 26 is complete, the real estate agent is allowed to make final changes to the data set utilizing a web browser session from the PC 23 to the web application server 26. This editing session allows the real estate agent to make any final changes, and allows the web application server to apply additional business rules designed to further reduce common mistakes made by real estate agents. The web application server 26, in conjunction with a specific web application can apply these rules to the data set and present any conflicting or incorrect data fields to the real estate agent for correction. Additional business rules which are enforced by the web application 26, which are not possible on the PCD 21, would be validation of property address, validation of legal property information, validation of subdivision names, validation of any fields which rely upon external systems for validation.

Once the real estate agent is satisfied with the data, the real estate agent may submit the data from the web application 26 to the regional MLS systems 27,28,29. The web application 26 may enforce additional business rules which dictate another authority must review the real estate listing before submission to the MLS systems. Some real estate agents operate in an environment where a mandatory 3^{rd} party reviews the data before submission. In this case, the web application 26 generates e-mail notifications to 3^{rd} party reviewers alerting them that there is listing data to review and submit.

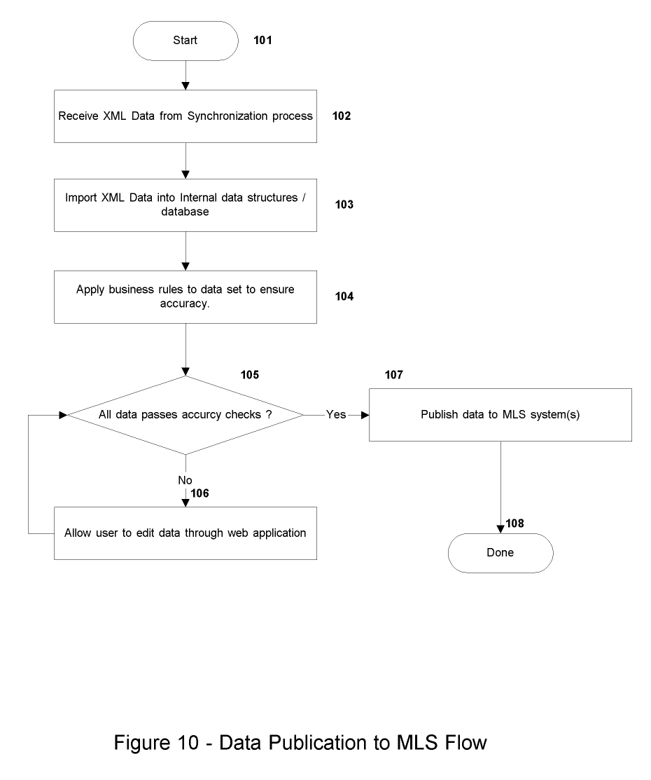

According to FIG. 10, the web application server 26 of FIG. 2, receives the XML data 102 representing user preferences and multiple listing data. This XML data is imported into local memory and database structures 103 and additional business rules are applied to the data 104. The submitting real estate agent is allowed to correct any data mistakes iteratively 105,106 until all mistakes are corrected. The web application server then publishes the corrected data to the regional MLS systems 107.

Submission of MLS data from the web application server 26 of FIG. 2 to a regional MLS 27,28,29 may take place over the Internet if the regional MLS accepts data in this manner. Alternate methods of data submission may involve modem-to-modem data exchanges, ftp data exchanges, e-mail data exchanges, VPN data exchanges, SNA or X.25 communication links are also be supported in addition to TCP/IP 2A.

Although the detailed description of the current invention utilizes examples based upon the single family data entry application. It should be noted that the current invention covers data collection and publication for all forms of real estate for sale, including but not limited to: single family residential, multi family residential, mobile homes, residential lots and lands, residential rental, common interest development, commercial lots and lands, commercial/industrial, business opportunity, and commercial rental.

The preferred embodiment of this invention uses the specific technologies and standards previously mentioned. The inventors have chosen these technologies because they are the emerging industry standards of today. The inventors also acknowledge other embodiments where:

A single purpose device such as an intelligent barcode scanner like the Opticon 9723 or the Symbol CS 1504/2000 Consumer Memory Scanner are used in conjunction with barcode labels to replace the specific application software running on the general purpose PCD.

Another type of data input device with storage memory is used to replace the specific application running on the general purpose PCD.

The synchronization cable connecting the general purpose PCD with the PC 22 of FIG. 2 is replaced with another communications medium (IrDA for example) for the purpose of uploading and synchronizing data from the PCD to the PC.

The specific web application and specific web services 26 of FIG. 2 are replaced by direct connections from the PC 23 to the regional MLS systems 27,28,29.

The Internet 22 of FIG. 2 is replaced by direct dial modem, leased line, fax, or other medium providing a communication channel linking the PC 23, the web application server 26, and the regional MLS systems 27,28,29

1. A system for providing remote data collection and upload of real estate listing information using a portable computing device, comprising:
a portable computing device configured with program code to collect and store real estate listing information in both transient and persistent memory,
a communications channel for the movement of collected data, programs, and configuration information to and from the portable computing device,
a database server comprising application code and database tables for the storage of collected real estate listing information, further comprising:
a daemon method to publish, periodically and on demand, newly collected listing information to a plurality of real estate multiple listing database systems.
one or more real estate multiple listing database systems to receive information collected on the portable computing device

2. A system as in claim 1 with the portable computing device further comprising:
a running application which interacts with the data collector to facilitate input and collection of real estate listing information
a structure in memory for the temporary and permanent storage of real estate listing information
a method for assessing the validity of said data based upon a plurality of rules imposed by the multiple listing database system and general best practices in the industry
a method for providing context sensitive terms and definitions, on the portable computing device, to be viewed by the data collector
a method in the portable computing device to exchange real estate listing data with external systems and to periodically receive program code updates

3. A system as in claim 1 with a communications channel for the movement of collected data, further comprising an intermittent data link between the portable computing device and the database server for the exchange of multiple listing data and the periodic exchange of application program code updates

4. A system as in claim 1 where the communications channel interfaces to the database server over a distributed network.

5. A system as in claim 1 with a database server further comprising:
a database schema for the collection and persistent storage of real estate listing information collected on the portable computing device
a method to further assess the validity of collected data based upon a plurality of rules imposed by the multiple listing database system and general best practices in the industry
a method to allow the data collector to edit and verify collected data over a remote user interface
a method and daemon to periodically and on demand publish the collected real estate listing data to a plurality of real estate multiple database listing systems

6. A system as in claim 1 with a multiple listing database system, as is standard in the real estate industry, further comprising a method and format to receive real estate listing data from external system

7. A portable computing device for collecting real estate listing information, comprising:
a general purpose device configured with program code to collect and store real estate listing information in both transient and persistent memory,
a specific application with display methods for the prompting, input, and collection of real estate listing information
an application configured to manage and display multiple exclusive sets of listing information
an application configured to apply validation rules, as imposed by the real estate multiple listing database systems, to the collected listing data.
an application configured to provide industry standard terms and definitions to the user based on the current display context

8. A portable computing device, as in claim 7, with specific application code to synchronize collected data and program code with external systems over a communication medium, further comprising a specific method to synchronize said collected real estate listing information data with external systems

9. A database server system for the collection and publication of said collected real estate listing information, comprising:
a database schema for the collection and persistent storage of real estate listing information collected on the portable computing device
a method to further assess the validity of collected data based upon a plurality of rules imposed by the multiple listing database system and general best practices in the industry
a method to allow the data collector to edit and verify collected data over a remote user interface
a method to accept collected real estate listing information into the database server's database schema a method and daemon to periodically and on demand publish the collected real estate listing data to a plurality of real estate multiple listing database systems

10. A database server as in claim 9 which accepts real estate multiple listing data, over a communications link, further comprising at least one of the following:
Internet link, intranet link, serial link, analog model link, digital modem link, cellular telephone link, telephone link, satellite link, radio frequency link, infrared link, fiber optic link, digital subscriber line link, cable modem link, coaxial cable link, and combinations thereof.
